(19) United States
(12) Patent Application Publication
(10) Pub. No.: US 2009/0008892 A1
(43) Pub. Date: Jan. 8, 2009

(54) SURFACE HARDENED SPHERICAL PLAIN BEARING

(75) Inventor: Brian Gaumer, Watertown, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 12/134,452

(22) Filed: Jun. 6, 2008

Related U.S. Application Data
(60) Provisional application No. 60/933,531, filed on Jun. 6, 2007.

(51) Int. Cl. B60G 3/06; F16C 33/10; C23C 8/20

(52) U.S. Cl. 280/124.145; 384/322; 148/207

(57) ABSTRACT

A spherical plain bearing for a heavy haul truck strut includes an outer ring and an inner ring. The outer ring includes an outer ring core disposed between a concave spherical first bearing surface and an exterior mounting surface. The inner ring includes an inner ring core disposed between a convex spherical second bearing surface and an interior surface. The inner ring is disposed within the outer ring with the first bearing surface engaging the second bearing surface. At least a portion of at least one of the first bearing surface, the second bearing surface, the exterior mounting surface and the interior surface has a hardness greater than that of at least one of the outer ring core and the inner ring core, for providing wear and impact resistance.

### CROSS REFERENCE TO RELATED APPLICATIONS

This application claims the benefit of U.S. provisional application No. 60/933,531 filed Jun. 6, 2007, which is incorporated herein by reference.

### FIELD OF THE INVENTION

The present invention is generally directed to a surface hardened spherical plain bearing and is more specifically directed to a surface hardened spherical plain bearing having a lubricant reservoir system for an axel strut assembly for heavy haul trucks that is capable of withstanding high impact loads and inadvertent lubricant supply interruptions.

### BACKGROUND OF THE INVENTION

Spherical plain bearings normally include inner and outer ring members. The outer ring member has a spherical concave interior surface that defines a cavity therein. The inner ring member is disposed in the cavity and has a spherical convex exterior surface that is complementary to, and is dimensioned to match, the concave interior surface of the outer ring member. The concave interior surface of the outer ring and the convex exterior surface of the inner ring are in sliding or bearing engagement with one another. The inner ring typically includes an inner ring bore therethrough having a mounting surface for engaging a shaft or pin and the outer ring includes an exterior mounting surface for engaging a housing.

Typically, spherical plain bearings are manufactured from a high strength through hardened steel such as AISI E52100. Through hardening of the steel imparts a high hardness through an entire core portion that is disposed within an equally hardened exterior surface thereof. The AISI E52100 steel provides good wear resistance but is brittle and has poor impact resistance.

As shown in FIGS. 1A and 1B, large haul mine trucks 200 have a rear strut assembly 210 including a strut 212 which connects an axel box portion 220 of the truck 200 to a frame portion 230 of the truck 200. A first pair of parallel oriented mounting plates 232 project from the frame 230 and a second pair of parallel oriented a mounting plates 222 project from the axel box 220. A spherical plain bearing 242 and 244 is mounted in each of two opposing ends of the strut 212 by fitting the exterior mounting surface of the outer ring into a mating surface of a bore disposed in the opposing ends of the strut. The spherical plain bearing 242 is coupled to the first pair of mounting plates 232 by a pin 250 and the spherical plain bearing 244 is coupled to the second pair of mounting plates 222 with another pin 252. A portion of each of the pins 250 and 252 engages the mounting surface of the inner ring bore and opposing ends of the pin engage complementary mating surfaces of bores disposed in each of the first and second pair of mounting plates 232 and 252. The arrangement of the strut 212, pins 250 and 252 and the spherical plain bearings 242 and 244 allows the strut to pivot about connection points 224 and 234 during operation.

It is known to provide a lubricant between the concave interior surface of the outer ring and the convex exterior surface of the inner ring of the spherical plain bearing. Some large haul mine trucks include a lubricant delivery system for supplying lubricant to the spherical plain bearings. The lubrication systems often include one or more lubrication supply tubes extending from a lubricant reservoir to the spherical plain bearings providing a path for replenishing lubrication to the spherical plain bearings. However, the truck can inadvertently engage objects on a job site causing the tubes to become damaged or severed. As a result, lubrication supply can become inadvertently interrupted causing premature failure of one or more of the spherical plain bearings.

It is also known to provide a lubrication groove in one of the concave interior surface of the outer ring and the convex exterior surface of the inner ring. Typically, the lubrication groove is in fluid communication with the lubricant delivery system. The lubrication groove distributes lubricant between the convex exterior surface and the concave interior surface as a result of relative sliding movement therebetween. The lubrication groove is also a reservoir for providing lubricant to the spherical plain bearing in the event of failure of the lubricant delivery system. In one configuration, the lubrication groove is a recess extending inwardly from the convex exterior surface of the inner ring within which a reserve of lubricant is disposed. The recess is open to the concave interior surface of the outer ring. In some spherical plain bearings, the recess is defined by two opposing walls extending inwardly from the convex exterior surface of the inner ring and intersecting a common base disposed on a valley portion of the recess. Such recesses can include sharp intersecting portions or stress razors from which surface cracks are known to propagate.

As is generally known, large haul mine trucks transport heavy loads over rough terrain. The struts are designed to absorb substantial impact loads imparted thereon by movement of the heavily loaded truck. However, such impact loads have been known to be transmitted not only to the struts but also to the joints (e.g., connection points 224 and 234) where the struts are coupled to the truck 200. As a result, surface cracks are caused on the concave interior surface of the outer ring and/or the convex exterior surface of the inner ring of the spherical plain bearing 242 and 244. The cracks typically propagate inwardly through the core portion due to the high hardness of the core portion of the inner and/or outer ring. Such propagation of the cracks through the core portion has resulted in catastrophic failure of the inner and/or the outer ring.

Thus there is a need to provide a spherical plain bearing that is impact and wear resistant and that can operate for a period of time without replenishment of the lubricant. Prior art methods and systems for addressing these needs were ineffective, too complicated or a combination thereof. Based on the foregoing, it is the general object of the present invention to improve upon prior art spherical plain bearings and overcome the perceived problems and drawbacks seen in their use in heavy haul truck applications.

### SUMMARY OF THE INVENTION

According to one aspect of the present invention, a spherical plain bearing for a heavy haul truck strut includes an outer ring and an inner ring. The outer ring includes an outer ring core disposed between a concave spherical first bearing surface and an exterior mounting surface. The inner ring includes an inner ring core disposed between a convex spherical second bearing surface and an interior surface. The inner ring is disposed within the outer ring with the first bearing surface engaging the second bearing surface. At least a portion of at least one of the first bearing surface, the second bearing surface, the exterior mounting surface and the interior surface has a hardness greater than that of at least one of the outer ring core and the inner ring core, for providing wear and impact resistance.

In another aspect of the present invention, at least one of the first bearing surface and the second bearing surface includes a plurality of lubrication grooves disposed therein. The hardness of at least a portion of at least one of the lubrication grooves and surfaces adjacent thereto is about equal to that of at least one of the outer ring core and the inner ring core.

In one aspect of the present invention a strut assembly for a heavy haul truck includes a strut having a first strut end with a first bore, having a first strut engaging surface, disposed therein and a second strut end including a second bore, having a second strut engaging surface, disposed therein. The spherical plain bearings each comprise an outer ring having an outer ring core disposed between a concave spherical first bearing surface and an exterior mounting surface. The spherical plain bearings include and an inner ring having an inner ring core disposed between a convex spherical second bearing surface and an interior surface, wherein the inner ring is disposed within the outer ring with the first bearing surface engaging the second bearing surface. One of the spherical bearings is disposed in the first bore with the exterior mounting surface engaging the first strut engaging surface. Another of the spherical bearings is disposed in the second bore with the exterior mounting surface engaging the second strut engaging surface. The first bearing surface, the second bearing surface, the exterior mounting surface and/or the interior surface have a hardness greater than that of the outer ring core and/or the inner ring core for providing wear and impact resistance.

In one aspect of the present invention, the strut assembly includes one or more pins having a pin core and an exterior pin mating surface. One of the pins is disposed within one of the inner rings with the interior surface engaging a portion of the exterior pin mating surface of one pin and another of the pins is disposed within another of the inner rings with the interior surface engaging a portion of the exterior pin mating surface of the other pin. The first bearing surface, the second bearing surface, the exterior mounting surface, the interior surface and/or the exterior pin mating surfaces have a hardness greater than that of the outer ring core, the inner ring core, and/or the pin core for providing wear and impact resistance.

The present invention also includes a method of hardening spherical plain bearings. The method includes providing a spherical plain bearing including an outer ring having a concave spherical first bearing surface and an exterior mounting surface and an inner ring having a convex spherical second bearing surface and an interior surface. The method also includes exposing at least a portion of at least one of the first bearing surface, the exterior mounting surface, the second bearing surface, and the interior surface to an atmosphere including carbon, for a predetermined period of time, such that the carbon diffuses therein to an effective case depth. The method further includes cooling at least one of the outer ring and the inner ring to an ambient temperature of about 70° F.

### DESCRIPTION OF THE DRAWINGS

FIG. 1A is a perspective view of the rear end of a prior art heavy haul vehicle.

FIG. 1B is a perspective view of a prior art strut assembly of a heavy haul vehicle.

FIG. 2 is a front cross sectional view of a strut assembly in accordance with the teachings of the present invention.

FIG. 3 is a cross sectional view of a spherical plain bearing.

FIG. 4 is an enlarged partial cross sectional view of the spherical plain bearing assembly of FIG. 3.

FIG. 5 is a partial cross sectional view of the spherical plain bearing assembly of FIG. 4 illustrating lubrication grooves.

FIG. 6 is a perspective view of the inner ring of FIG. 5.

FIG. 7 is an enlarged partial cross sectional view of a portion of a second lubrication groove having a mask disposed thereon.

### DETAILED DESCRIPTION OF THE PREFERRED EMBODIMENT

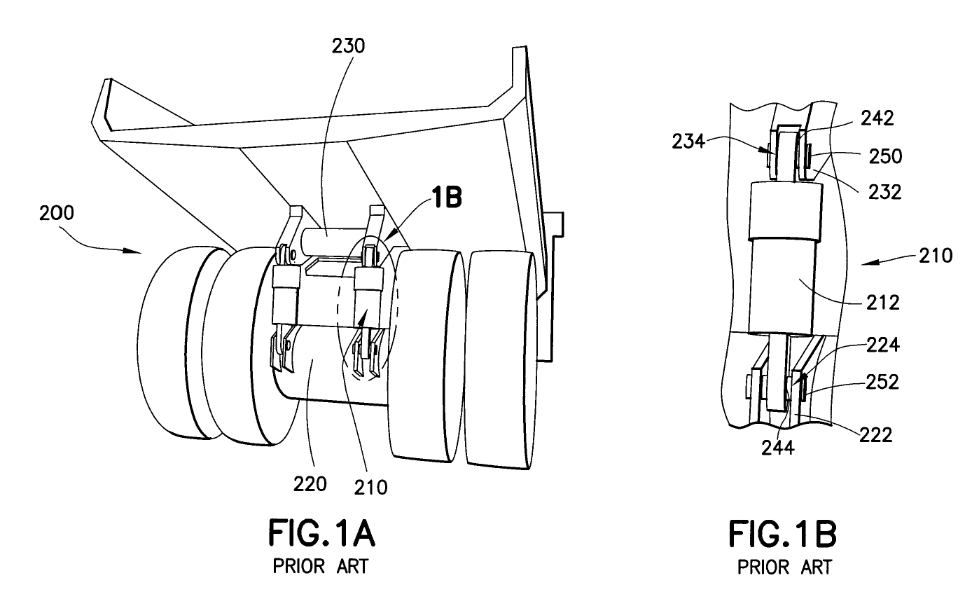

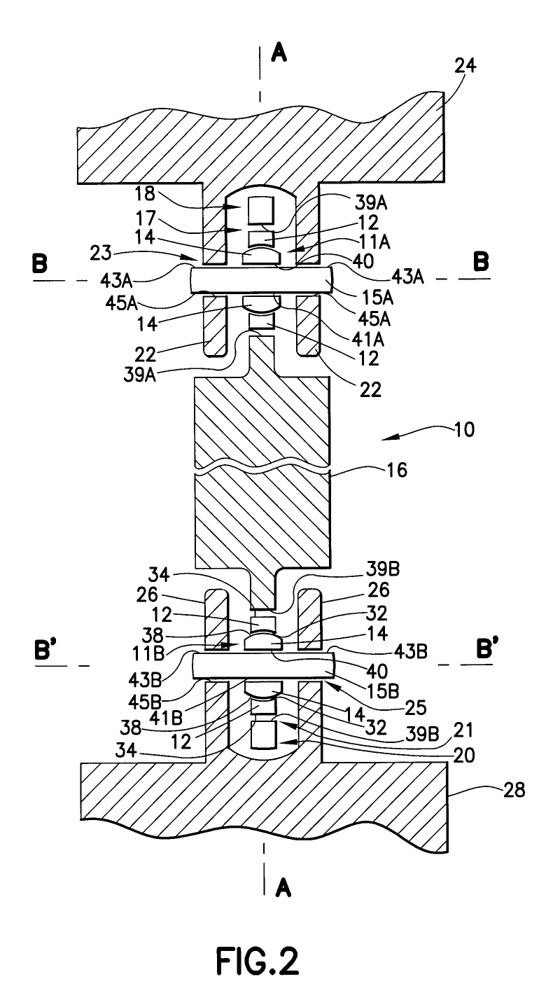

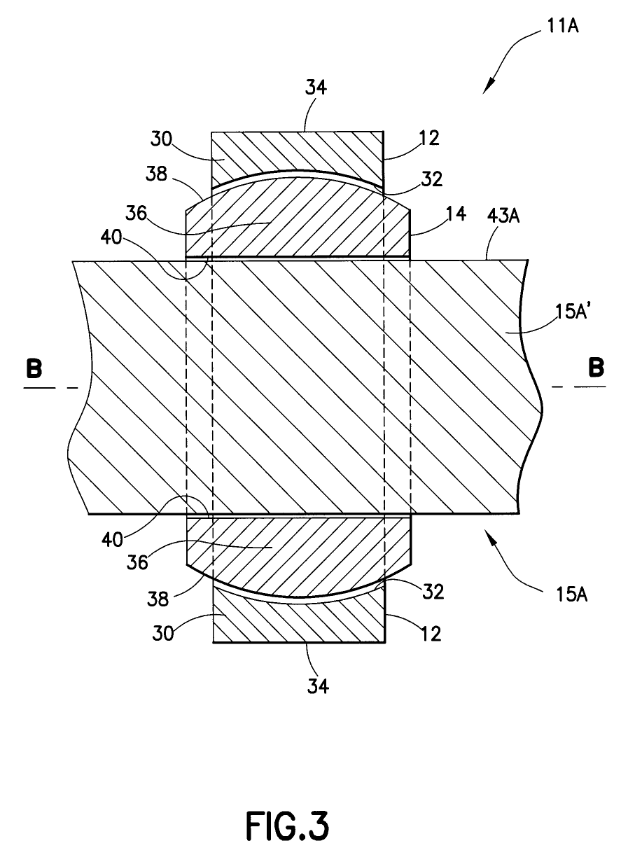

As illustrated in FIG. 2, a strut assembly 10 includes one or more spherical plain bearing 11A and 11B. In one embodiment the strut assembly 10 is deployed on a heavy haul truck, for example, a heavy haul truck used in mining operations as shown if FIG. 1A. The spherical plain bearings 11A and 11B each include an outer ring 12 and an inner ring 14, disposed therein. The strut assembly 10 includes a pair of connecting pins 15A and 15B and a strut 16 having a frame end 18 and an axel end 20. The frame end 18 and the axel end 20 are movable relative to one another along a longitudinal axis A of the strut 16. The strut assembly 10 also includes a pair of frame mounting plates 22 projecting from a frame portion 24 of the truck and a pair of axel mounting plates 26 projecting from an axel housing portion 28 of the truck. The spherical bearing 11A and the connecting pin 15A pivotally couple the frame end 18 to the frame mounting plates 22, as described in detail below. The spherical bearing 11B and the connecting pin 15B pivotally couple the axel end 20 to the axel mounting plates 26, as described in detail below.

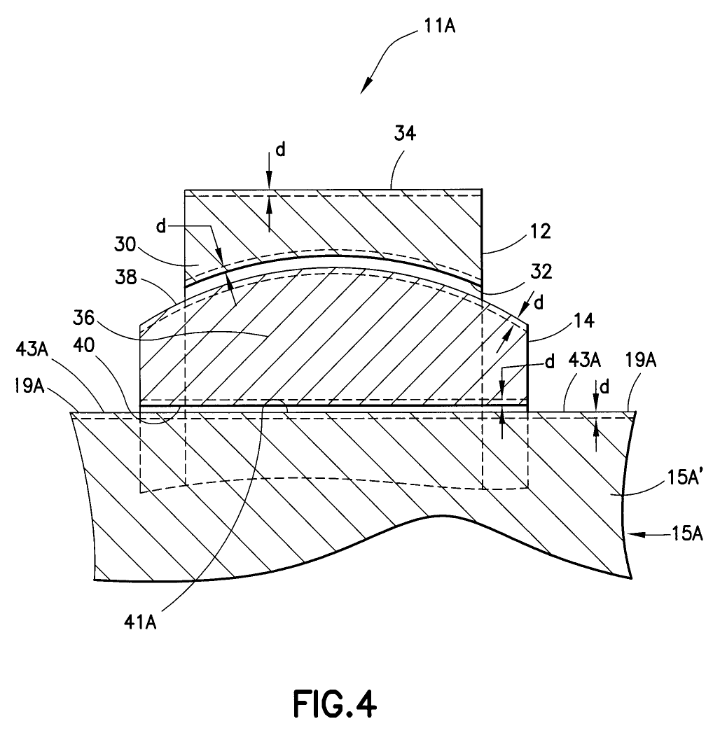

FIGS. 3-4 illustrate the spherical plain bearing 11A with the outer ring 12 shown having an outer ring core region 30 disposed between a concave spherical first bearing surface 32 and an exterior mounting surface 34. The inner ring 14 includes an inner ring core region 36 disposed between a convex spherical second bearing surface 38 and an interior surface 40. The inner ring 14 is disposed within the outer ring 12 with the first bearing surface 32 engaging the second bearing surface 38 for rotational movement therebetween.

Referring to FIG. 3-4, in one embodiment, the pins 15A and 15B have respective pin core regions 15A′ and 15B′ and respective exterior pin mating surfaces 19A and 19B. Referring back to FIG. 2, the exterior mounting surface 34 of one of the spherical plain bearings 11A is secured in a first bore 17 disposed in the frame end 18 of the strut 16. The first bore 17 has a strut engaging surface 39A therein which engages the exterior mounting surface 34 of the spherical plain bearings 11A. As illustrated in FIG. 4, the exterior pin mating surface 19A includes a centrally disposed circumferential surface 41A and distally disposed circumferential surfaces 43A on opposing ends of the pin 15A. The centrally disposed surface 41A engages the interior surface 40 of the inner ring 14. The distally disposed surface 43A engages frame mounting surfaces 45A of a frame bore 23 disposed in the frame mounting plates 22. The pin 15A, the first bore 17, the frame bore 23 and the spherical bearing 11A are aligned along axis B. The exterior mounting surface 34 of the spherical plain bearings 11B is secured in a second bore 21 disposed in the axel end 20 of the strut 16. The second bore 21 has a strut engaging surface 39B therein which engages the exterior mounting surface 34 of the spherical plain bearings 11B. The exterior pin mating surface 19B includes a centrally disposed circumferential surface 41B and distally disposed circumferential surfaces 43B on opposing ends of the pin 15B. The centrally disposed surface 41B engages the interior surface 40 of the inner ring 14. The distally disposed surfaces 43B engage axel mounting surfaces 45B of an axel bore 25 disposed in the axel mounting plates 26. The pin 15B, the second bore 21, the axel bore 25 and the spherical bearing 11B are aligned along axis B′.

In one embodiment, the outer ring 12, the inner ring 14 and/or the pins 15A and 15B are manufactured from carbon steel. In one embodiment, the outer ring 12, the inner ring 14 and/or the pins 15A and 15B are manufactured from a low-carbon steel having a carbon content of less than approximately 0.25% carbon by weight. Portions of the first bearing surface 32, the second bearing surface 38, the exterior mounting surface 34, the interior surface 40 and/or the exterior pin mating surfaces 19A and 19B have a hardness greater than that of the outer ring core region 30, the inner ring core region 36 and/or the pin core region. Thus the hardened portions of the first bearing surface 32, the second bearing surface 38, the exterior mounting surface 34, the interior surface 40 and/or the exterior pin mating surfaces 19A and 19B have high wear resistance. The ductile outer ring core region 30, the inner ring core region 36 and/or the pin core region have impact resistance. In one embodiment, portions of the first bearing surface 32, the second bearing surface 38, the exterior mounting surface 34, the interior surface 40 and/or the exterior pin mating surfaces 19A and 19B have a Rockwell hardness, C scale, of at least 59.

In one embodiment, the outer ring core region 30, the inner ring core region 36 and/or pin core regions 15A′ and 15B′ have sufficient ductility, toughness and/or impact resistance to withstand impact loads, imparted by, for example a heavy haul truck, on the strut 16, the spherical plain bearings 11A and 11B and the pins 15A and 15B. The ductility, toughness and/or impact resistance of the outer ring core region 30, the inner ring core region 36 and/or pin core regions 15A′ and 15B′ inhibits surface cracks from propagating inwardly thus substantially preventing catastrophic failure of the spherical plain bearings 11A and 11B and the pins 15A and 15B. In one embodiment, the ductility, toughness and/or impact resistance is achieved by manufacturing the outer ring 12, the inner ring 14 and pins 15A and 15B from a low-carbon steel and maintaining the carbon content of the outer ring core region 30, the inner ring core region 36 and the pin core regions 15A′ and 15B′ below about 0.25% carbon content, by weight. The spherical plain bearing 11B and pin 15B are configured similar to and have similar surface hardness, ductility, toughness and/or impact resistance to that described above for the spherical plain bearing 11A and pin 15A, respectively.

FIG. 4 illustrates the first bearing surface 32, the second bearing surface 38, the exterior mounting surface 34, the interior surface 40 and the exterior pin mating surfaces 19A and 19B, on each, having an effective case depth d. The effective case depth d is a distance from a case hardened exterior surface to a furthest point, interior to the case hardened exterior surface, at which the Rockwell hardness, C scale, is 50. The effective case depth d is measured perpendicular to the case hardened exterior surface. In one embodiment, the case depth d is about 0.063 inch (1.6002 mm).

Hardening of the first bearing surface 32, the second bearing surface 38, the exterior mounting surface 34 the interior surface 40 and/or exterior pin mating surfaces 19A and 19B, collectively referred to as “host surfaces” is accomplished, in one embodiment, with a surface hardening process. In one embodiment, the surface hardening process includes one of gas diffusion, pack diffusion and liquid diffusion carburization. In one embodiment, the host surfaces, or a portion thereof, are exposed to a carbon rich atmosphere (e.g., carbon monoxide, carbon powder, or a molten carbon rich bath) for a predetermined period of time. In one embodiment, the carbon rich atmosphere is at a temperature between approximately 1550° F. to 1750° F. The temperature and time are selected based on a desired surface hardness and effective case depth. Portions of the host surfaces which do not require hardening are coated with a mask (e.g., mask 170 of FIG. 7), prior to initiation of the surface hardening process. The mask is made up of a substance impermeable to carbon, for example copper, to preclude diffusion of carbon into the masked portions of the host surfaces not to be hardened. In one embodiment, the mask is deposited on the portions of the host surfaces not to be hardened by an electro-chemical plating process. During the carburization process, carbon diffuses into the host surfaces thereby increasing concentration of the carbon at the host surfaces exposed to the carbon rich atmosphere and within the effective case depth. After carburization, the outer ring 12 and/or the inner ring 14 are cooled to an ambient temperature of approximately 70° F. to achieve a desired surface hardness. In one embodiment, the outer ring 12 and/or the inner ring 14 are cooled to ambient temperature by quenching in a liquid. In another embodiment, the outer ring 12 and/or the inner ring 14 are cooled to ambient temperature in still air. Subsequently, the mask is removed. While the carburization process is described for hardening the host surfaces, the present invention is not limited in this regard as the present invention is adaptable to other hardening processes including, but not limited to, nitriding wherein nitrogen is diffused into the host surface, carbonitriding wherein carbon and nitrogen are diffused into the host surface, flame hardening, induction hardening, laser beam hardening and electron beam hardening. Although the mask 170 is described as being copper, the present invention is not limited in this regard as other coatings are also suitable including but not limited to water soluble coatings.

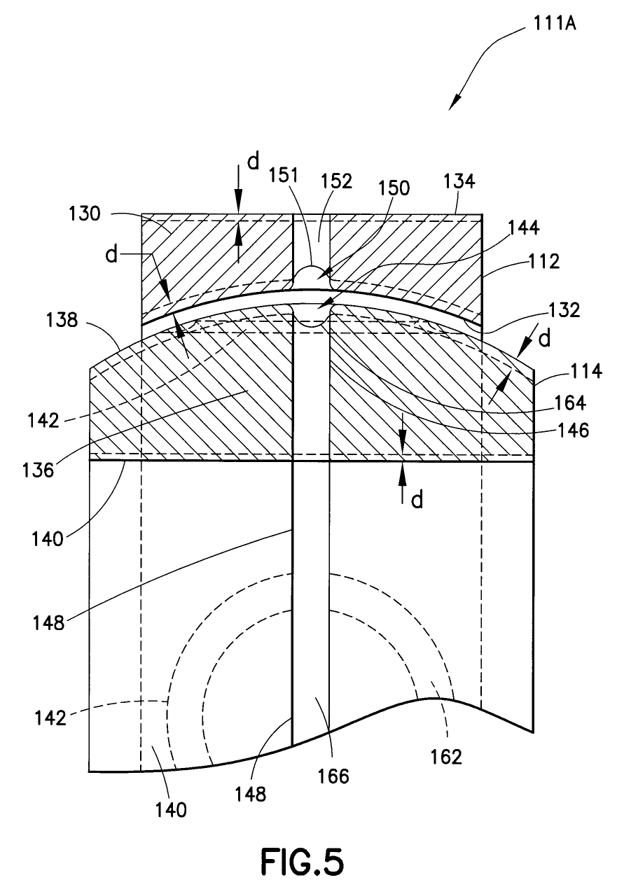

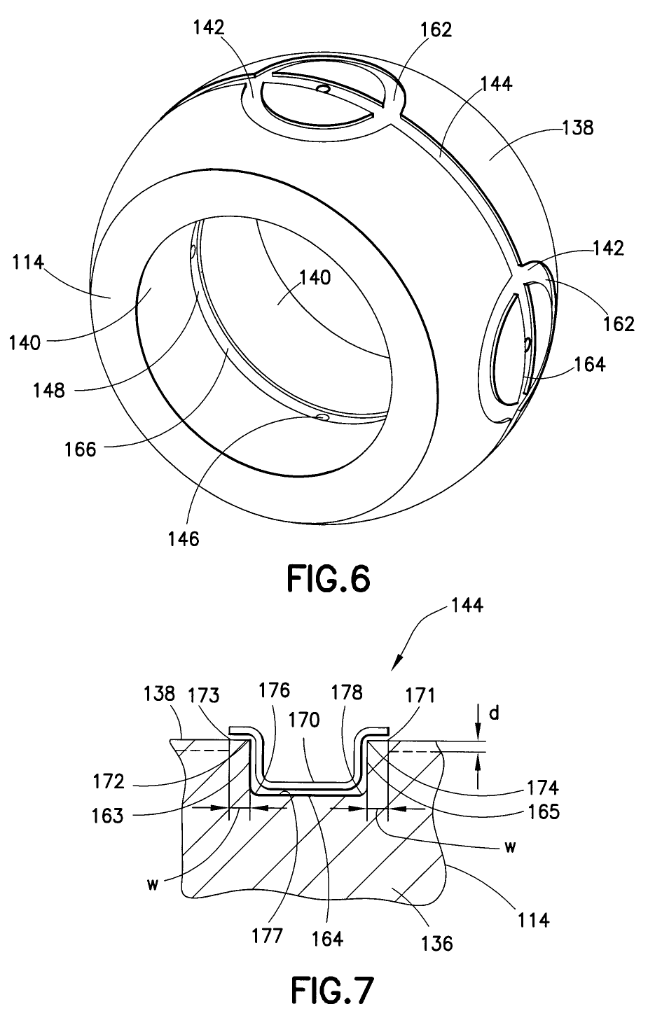

The embodiment shown in FIGS. 5-7 is similar to that of FIGS. 2-4, therefore like elements will be given like numbers preceded by the numeral 1. Referring to FIGS. 5-6, an inner ring 114 is illustrated having a plurality of circular first lubrication grooves 142 in fluid communication with a transversely positioned second lubrication groove 144, disposed in a second bearing surface 138. A first lubrication supply aperture 146 transverses a core region 136 of the inner ring 114 and is in fluid communication with a third lubrication groove 148 disposed in an interior surface 140 of the inner ring 114, for exchanging lubricant therewith. Referring to FIG. 5, an outer ring 112 includes a fourth lubrication groove 150 circumferentially disposed on a first bearing surface 132. A second lubrication supply aperture 152 extends through a core portion 130 of the outer ring 112 from the exterior mounting surface 134 to the first bearing surface 132 and the fourth lubrication grove 150, for supplying lubrication thereto. The plurality of first lubrication grooves 142 include a first valley portion 162; the second lubrication groove 144 includes a second valley portion 164; the third lubrication groove 148 includes a third valley portion 166; and the fourth lubrication groove 150 includes a fourth valley portion 151.

While a plurality of circular first lubrication grooves 142 in fluid communication with a transversely positioned second lubrication groove 144 disposed in the second bearing surface 138, a third lubrication groove 148 disposed in the interior surface 140 and a fourth lubrication groove 150 circumferentially disposed on the first bearing surface 132 is described, the present invention is not limited in this regard as other configurations of the first, second third and fourth lubrication grooves are also within the scope of the present invention including, but not limited to, T-shaped configurations, configurations having multiple linear segments which intersect, curved configurations and/or combinations thereof.

Referring to FIG. 7, in one embodiment, the second lubrication groove 144 includes a first wall 163 extending inwardly from the second bearing surface 138 at a first edge 172 and a second wall 165 extending inwardly from the second bearing surface 138 at a second edge 174. The first wall 163 and the second wall 165 are spaced apart by the second valley portion 164 and intersect therewith at a first corner 176 and a second corner 178, respectively. The first edge 172, the second edge 174, the first corner 176 and the second corner 178 are stress razors susceptible to crack propagation therefrom. During manufacture of the inner ring 114, a mask 170 is disposed on a portion thereof defining a coverage area 177 thereunder, to preclude the coverage area from becoming surface hardened. Before and after surface hardening of the second bearing surface 138 of the inner ring 114, the surface hardness of the first edge 172, the second edge 174, the first corner 176 and the second corner 178 are about equal to that of the inner ring core region 136 and have similar ductility, toughness and impact resistance to that of the inner core region 136 to help mitigate propagation of cracks. The coverage area 177 is defined by a portion of the second bearing surface 138 between a first buffer point 173 spaced apart from the first edge 172 by a distance W, the first edge 172, the first wall 163, the first corner 176, the first valley portion 164, the second corner 178, the second wall 165, the second edge 174 and another portion of the second bearing surface 138 between the second edge 174 and a second buffer point 171 spaced apart from the second edge 174 by the distance W.

While portions of the inner ring 114 adjacent to the second lubrication groove 144 are described as including the mask prior to and during the hard surfacing process, the present invention is not limited in this regard as one or more of the first lubrication groove 142, the third lubrication groove 148 and the fourth lubrication groove 150 are also adaptable to using the mask 170 to preclude hard surfacing of portions thereof. It should be appreciated that other coverage areas are also within the scope of the present invention including but not limited to portions of the coverage areas described hereinabove.

A method for hardening a spherical plain bearing 11 A and 11B is provided. The method includes providing a spherical plain bearing 11A including an outer ring 12 having a concave spherical first bearing surface 32 and an exterior mounting surface 34 and an inner ring 14 having a convex spherical second bearing surface 38 and an interior surface 40. The method also includes exposing at least a portion of at least one of the first bearing surface 32, the exterior mounting surface 34, the second bearing surface 38, and the interior surface 40 to an atmosphere including carbon for a predetermined period of time, such that the carbon diffuses therein to an effective case depth (d). In one embodiment, the method includes maintaining the atmosphere at a temperature of about 1550° F. to about 1750° F. for the predetermined period of time. The method further includes cooling at least one of the outer ring 12 and the inner ring 14 to an ambient temperature of approximately 70° F.

In one embodiment of the method, at least one of the first bearing surface 32, the second bearing surface 38, the exterior mounting surface 34 and the interior surface 40 has a Rockwell C scale hardness of at least 59. In another embodiment, the effective case depth (d) of at least one of the first bearing surface 32, the second bearing surface 38, the exterior mounting surface 34 and the interior surface 40 is about 0.063 inches.

In one embodiment of the method, lubrication grooves are disposed in the first bearing surface 32, the exterior mounting surface 34, the second bearing surface 38, and the interior surface 40. Prior to exposing at least a portion of at least one of the first bearing surface 32, the exterior mounting surface 34, the second bearing surface 38, and the interior surface 40 to the atmosphere including the carbon, the method includes coating at least a portion of at least one of the lubrication grooves and adjacent surfaces with a mask 170 to preclude diffusion of the carbon therethrough.

Although the present invention has been disclosed and described with reference to certain embodiments thereof, it should be noted that other variations and modifications may be made, and it is intended that the following claims cover the variations and modifications within the true scope of the invention.

What is claimed is:

1. A spherical plain bearing comprising:
an outer ring comprising an outer ring core disposed between a concave spherical first bearing surface and an exterior mounting surface;
an inner ring comprising an inner ring core disposed between a convex spherical second bearing surface and an interior surface;
wherein said inner ring is disposed within said outer ring with said first bearing surface engaging said second bearing surface;
at least a portion of at least one of said first bearing surface, said second bearing surface, said exterior mounting surface and said interior surface has a hardness greater than that of at least one of said outer ring core and said inner ring core, for providing wear and impact resistance.

2. The spherical plain bearing of claim 1, wherein at least one of said first bearing surface, said second bearing surface, said exterior mounting surface and said interior surface has a Rockwell C scale hardness of at least 59.

3. The spherical plain bearing of claim 1, wherein at least one of said first bearing surface, said second bearing surface, said exterior mounting surface and said interior surface has an effective case depth of about 0.063 inches.

4. The spherical plain bearing of claim 1, wherein at least one of said first bearing surface and said second bearing surface comprises a plurality of lubrication grooves disposed therein.

5. The spherical plain bearing of claim 4, wherein the hardness of at least a portion of at least one of said lubrication grooves and surfaces adjacent thereto is about equal to that of at least one of said outer ring core and said inner ring core.

6. A method of hardening spherical plain bearings comprising the steps of:
providing a spherical plain bearing including an outer ring having a concave spherical first bearing surface and an exterior mounting surface and an inner ring having a convex spherical second bearing surface and an interior surface;
exposing at least a portion of at least one of said first bearing surface, said exterior mounting surface, said second bearing surface, and said interior surface to an atmosphere comprising carbon, for a predetermined period of time, such that the carbon diffuses therein to an effective case depth; and
cooling at least one of said outer ring and said inner ring to an ambient temperature.

7. The method of claim 6, including the step of:
maintaining the atmosphere at a temperature of about 1550° F. to about 1750° F. for the predetermined period of time.

8. The method of claim 6, wherein at least one of said first bearing surface, said second bearing surface, said exterior mounting surface and said interior surface has a Rockwell C scale hardness of at least 59.

9. The method of claim 6, wherein the effective case depth of at least one of said first bearing surface, said second bearing surface, said exterior mounting surface and said interior surface is, at most, about 0.063 inches.

10. The method of claim 6, including:
forming at least one lubrication groove in at least one of said first bearing surface, said exterior mounting surface, said second bearing surface, and said interior surface; and
coating at least a portion of at least one of said lubrication grooves and adjacent surfaces with a mask to preclude diffusion of the carbon therethrough, prior to said exposing at least a portion of at least one of said first bearing surface, said exterior mounting surface, said second bearing surface, and said interior surface to said atmosphere comprising said carbon.

11. A strut assembly comprising:
a strut comprising a truck-frame end including a first bore having a first strut engaging surface and a truck-axel end including a second bore having a second strut engaging surface;
at least one spherical plain bearing, the at least one spherical plain bearing comprising an outer ring having an outer ring core disposed between a concave spherical first bearing surface and an exterior mounting surface, an inner ring having an inner ring core disposed between a convex spherical second bearing surface and an interior surface, wherein said inner ring is disposed within said outer ring with said first bearing surface engaging said second bearing surface, one of said at least one spherical bearings is disposed in said first bore with said exterior mounting surface engaging said first strut engaging surface, at least one spherical bearings is disposed in said second bore with said exterior mounting surface engaging said second strut engaging surface; and
at least a portion of at least one of said first bearing surface, said second bearing surface, said exterior mounting surface and said interior surface has a hardness greater than that of at least one of said outer ring core and said inner ring core for providing wear and impact resistance.

12. The strut assembly of claim 11 further comprising:
at least one pin comprising a pin core and an exterior pin mating surface, wherein one of said at least one pins is disposed within one of said at least one inner rings with said interior surface engaging a portion of said exterior pin mating surface of one pin and another of said at least one pins is disposed within another of said at least one inner rings with said interior surface engaging a portion of said exterior pin mating surface of the other pin; and
at least a portion of at least one of said first bearing surface, said second bearing surface, said exterior mounting surface, said interior surface and said exterior pin mating surface has a hardness greater than that of at least one of said outer ring core, said inner ring core, and said pin core for providing wear and impact resistance.

13. The spherical plain bearing of claim 12 wherein at least one of said outer ring core, said inner ring core and said pin core comprise a carbon steel and wherein at least one of said first bearing surface, said second bearing surface, said exterior mounting surface, said interior surface and said exterior pin mating surface is surface hardened to Rockwell C 59 or greater.

14. The spherical plain bearing of claim 12 wherein at least one of said first bearing surface, said second bearing surface, said exterior mounting surface, said interior surface and said exterior pin mating surface has an effective case depth of less than or equal to about 0.063 inches.

15. The spherical plain bearing of claim 11 wherein at least one of said first bearing surface and said second bearing surface comprises a plurality of lubrication grooves disposed therein.
